(19) United States
(12) Patent Application Publication
(10) Pub. No.: US 2026/0219888 A1
(43) Pub. Date: Jul. 30, 2026

(54) VARIABLE-LENGTH INSTRUCTION SET MODE

(71) Applicant: Arm Limited, Cambridge (GB)

(72) Inventor: Simon John CRASKE, Cambridge (GB)

(21) Appl. No.: 19/041,031

(22) Filed: Jan. 30, 2025

(51) Int. Cl. G06F 9/30; G06F 9/38

(52) U.S. Cl. CPC G06F 9/30149; G06F 9/30047; G06F 9/30054; G06F 9/3861

(57) ABSTRACT

In a variable-length instruction set mode, front end circuitry decodes instructions according to an encoding scheme based on an architectural encoding constraint requiring that a given instruction is encoded fully within a G-bit fetch granule, where G is a fixed power-of-2 integer, and no valid instruction is allowed to cross a boundary between G-bit fetch granules. A predetermined subset of bit positions within a given G-bit fetch granule is used to determine whether the granule is encoded according to a first subset of valid encodings encoding instructions corresponding to instructions of a fixed-length legacy instruction set, or a second subset of valid encodings encoding, according to a layout identified by a layout descriptor in the predetermined subset of bit positions, one or more instructions including at least one instruction of different length to the instructions encoded in the first subset of valid encodings.

### BACKGROUND

### Technical Field

The present technique relates to the field of data processing.

### Technical Background

A data processing apparatus has processing circuitry to perform data processing in response to instructions decoded by an instruction decoder. The format of the instruction encoding and the functionality represented by each instruction may be defined according to an instruction set architecture (ISA). The ISA represents the agreed framework between the hardware manufacturer who manufactures the processing hardware for a given processor implementation and the software developer who writes code to execute on that hardware, so that code written according to the ISA will function correctly on hardware supporting that ISA. When designing an ISA, there can be a significant design challenge in determining how to implement the instruction set supported by the processing apparatus, including deciding the instruction length for the instructions, the set of processing operations to be supported in the instruction set, and the particular encoding of the instructions which represent those operations. Design decisions made when designing the ISA may have a significant impact on the circuit area and power consumption incurred on hardware which implements the ISA, and on processing performance experienced by software that is written in accordance with the ISA. An ISA may define architectural constraints to be satisfied by hardware designers, which can leave some flexibility for different hardware implementations to take different approaches for satisfying those constraints, e.g. with one hardware implementation prioritising improved processing performance over circuit area/power efficiency, and another hardware implementation prioritising a reduction in circuit area and power consumption even if that is at the expense of reduced processing performance.

### SUMMARY

At least some examples of the present technique provide an apparatus comprising: front end circuitry configured to fetch and decode instructions; and processing circuitry configured to perform data processing operations in response to instructions decoded by the front end circuitry; in which: in a variable-length instruction set mode for processing instructions from a variable-length instruction set supporting instructions with different instruction lengths, the front end circuitry is configured to decode the instructions according to an encoding scheme in which each instruction is required to meet an architectural encoding constraint requiring that, for a given instruction processed in the variable-length instruction set mode, the given instruction is encoded fully within a G-bit fetch granule, where G is a fixed power-of-2 integer, and no valid instruction is allowed to cross a boundary between G-bit fetch granules; in the variable-length instruction set mode, the front end circuitry is configured to decode a given G-bit fetch granule to determine, based on a predetermined subset of bit positions within the given G-bit fetch granule, whether the G-bit fetch granule is encoded according to a first subset of valid fetch granule encodings or a second subset of valid fetch granule encodings; in each of the first subset of valid fetch granule encodings, the given G-bit fetch granule encodes a plurality of instructions of the variable-length instruction set having encodings corresponding to fixed-length instructions supported in a predetermined fixed-length legacy instruction set; and in each of the second subset of valid fetch granule encodings, the given G-bit fetch granule encodes one or more instructions of the variable-length instruction set, including at least one instruction with a different instruction length to the instructions encoded in the first subset of valid fetch granule encodings, with a layout of the one or more instructions of the variable-length instruction set in the G-bit fetch granule identified by a layout descriptor encoded using the predetermined subset of bit positions of the given G-bit fetch granule.

At least some examples of the present technique provide a system comprising: the apparatus described above, implemented in at least one packaged chip; at least one system component; and a board, wherein the at least one packaged chip and the at least one system component are assembled on the board.

At least some examples of the present technique provide a chip-containing product comprising the system described above, wherein the system is assembled on a further board with at least one other product component.

At least some examples of the present technique provide computer-readable code for fabrication of an apparatus as described above.

The computer-readable code may be stored on a storage medium. The storage medium may be a non-transitory storage medium.

At least some examples of the present technique provide a computer program comprising instructions which, when executed by a host data processing apparatus, control the host data processing apparatus to provide an instruction execution environment for execution of target program code, the computer program comprising: front end program logic configured to fetch and decode instructions of the target program code; and processing program logic configured to control the host data processing apparatus to perform data processing operations in response to the instructions fetched and decoded by the front end program logic; in which: in a variable-length instruction set mode for processing instructions from a variable-length instruction set supporting instructions with different instruction lengths, the front end program logic is configured to decode the instructions according to an encoding scheme in which each instruction is required to meet an architectural encoding constraint requiring that, for a given instruction processed in the variable-length instruction set mode, the given instruction is encoded fully within a G-bit fetch granule, where G is a fixed power-of-2 integer, and no valid instruction is allowed to cross a boundary between G-bit fetch granules; in the variable-length instruction set mode, the front end program logic is configured to decode a given G-bit fetch granule to determine, based on a predetermined subset of bit positions within the given G-bit fetch granule, whether the G-bit fetch granule is encoded according to a first subset of valid fetch granule encodings or a second subset of valid fetch granule encodings; in each of the first subset of valid fetch granule encodings, the given G-bit fetch granule encodes a plurality of instructions of the variable-length instruction set having encodings corresponding to fixed-length instructions supported in a predetermined fixed-length legacy instruction set; and in each of the second subset of valid fetch granule encodings, the given G-bit fetch granule encodes one or more instructions of the variable-length instruction set, including at least one instruction with a different instruction length to the instructions encoded in the first subset of valid fetch granule encodings, with a layout of the one or more instructions of the variable-length instruction set in the G-bit fetch granule identified by a layout descriptor encoded using the predetermined subset of bit positions of the given G-bit fetch granule.

The computer program may be stored on a storage medium. The storage medium may be a non-transitory storage medium.

At least some examples of the present technique provide a method comprising: fetching and decoding instructions using front end circuitry; and in response to the instructions fetched and decoded by the front end circuitry, performing data processing operations using processing circuitry; in which: in a variable-length instruction set mode for processing instructions from a variable-length instruction set supporting instructions with different instruction lengths, the front end circuitry decodes the instructions according to an encoding scheme in which each instruction is required to meet an architectural encoding constraint requiring that, for a given instruction processed in the variable-length instruction set mode, the given instruction is encoded fully within a G-bit fetch granule, where G is a fixed power-of-2 integer, and no valid instruction is allowed to cross a boundary between G-bit fetch granules; in the variable-length instruction set mode, decoding of a given G-bit fetch granule comprises determining, based on a predetermined subset of bit positions within the given G-bit fetch granule, whether the G-bit fetch granule is encoded according to a first subset of valid fetch granule encodings or a second subset of valid fetch granule encodings; in each of the first subset of valid fetch granule encodings, the given G-bit fetch granule encodes a plurality of instructions of the variable-length instruction set having encodings corresponding to fixed-length instructions supported in a predetermined fixed-length legacy instruction set; and in each of the second subset of valid fetch granule encodings, the given G-bit fetch granule encodes one or more instructions of the variable-length instruction set, including at least one instruction with a different instruction length to the instructions encoded in the first subset of valid fetch granule encodings, with a layout of the one or more instructions of the variable-length instruction set in the G-bit fetch granule identified by a layout descriptor encoded using the predetermined subset of bit positions of the given G-bit fetch granule.

Further aspects, features and advantages of the present technique will be apparent from the following description of examples, which is to be read in conjunction with the accompanying drawings.

### BRIEF DESCRIPTION OF THE DRAWINGS

FIG. 1 illustrates an example of an apparatus comprising front end circuitry and processing circuitry;

FIG. 2 illustrates an example of variable-length instructions to be processed in a variable-length instruction set mode;

FIG. 3 illustrates an example of an architectural encoding constraint to be satisfied by a given instruction processed in the variable-length instruction set mode, in which the given instruction is required to be encoded fully within a G-bit fetch granule without crossing a boundary between G-bit fetch granules;

FIG. 4 illustrates an example encoding of a program counter for the variable-length instruction set mode;

FIG. 5 illustrates a more detailed example of a processing apparatus;

FIG. 6 illustrates an example of pre-decoding, caching, fetching, and decoding instructions in the variable-length instruction set mode;

FIG. 7 illustrates an example of steps for processing instructions in the variable-length instruction set mode;

FIG. 8 illustrates an example of steps for detecting an attempt to branch to an invalid branch target corresponding to a mid-point of an instruction;

FIG. 9 illustrates another example of fetch granule encodings in the variable-length instruction set mode;

FIG. 10 illustrates a system and a chip-containing product; and

FIG. 11 illustrates a simulation example.

### DESCRIPTION OF EXAMPLES

Instruction set architecture (ISA) designers may face pressure to add new instructions to the instruction set supported by a processing apparatus, but may need to balance the performance benefits to software expected from any additional instructions with the hardware cost of increased complexity for processor hardware designers to implement new instructions. For any given instruction length, there is a limited amount of encoding space. Simply increasing the instruction length of all instructions to accommodate encoding space for new instructions may impose additional hardware costs, from the circuit area and power incurred in storing wider instructions in caches and memory, wider signal paths for passing instructions from one location to another, and more complex instruction decoding circuit logic. Variable-length instruction sets, which include instructions of different instruction lengths, can help to increase the available encoding space beyond that available from a fixed-length instruction set of a shortest instruction length supported, and improve code density by providing the ability to encode more instructions in a given memory footprint. However, it is recognised that typical variable-length instruction sets pose a challenge for front end circuitry of a processing apparatus, because the instruction alignment in memory address space becomes irregular, depending on the relative position of shorter and longer instructions. In typical variable-length instruction sets, the granularity with which instructions are fetched from a cache or memory is not aligned to the instruction size, so that it is possible for a longer instruction to span multiple fetch granules. This increases the complexity of implementing instruction pre-decoding or decoding circuitry (e.g. requiring buffering circuitry to retain a first part of an instruction fetched from a fetch granule fetched in one cycle while fetching a second part of the same instruction from another fetch granule fetched in a different cycle).

In examples discussed below, an apparatus comprises front end circuitry configured to fetch and decode instructions; and processing circuitry configured to perform data processing operations in response to instructions decoded by the front end circuitry. In a variable-length instruction set mode for processing instructions from a variable-length instruction set supporting instructions with different instruction lengths, the front end circuitry is configured to decode the instructions according to an encoding scheme in which each instruction is required to meet an architectural encoding constraint requiring that, for a given instruction processed in the variable-length instruction set mode, the given instruction is encoded fully within a G-bit fetch granule, where G is a fixed power-of-2 integer; and no valid instruction is allowed to cross a boundary between G-bit fetch granules. In the variable-length instruction set mode, the front end circuitry decodes a given G-bit fetch granule to determine, based on a predetermined subset of bit positions within the given G-bit fetch granule, whether the G-bit fetch granule is encoded according to a first subset of valid fetch granule encodings or a second subset of valid fetch granule encodings. In each of the first subset of valid fetch granule encodings, the given G-bit fetch granule encodes a plurality of instructions of the variable-length instruction set having encodings corresponding to fixed-length instructions supported in a predetermined fixed-length legacy instruction set. In each of the second subset of valid fetch granule encodings, the given G-bit fetch granule encodes one or more instructions of the variable-length instruction set, including at least one instruction with a different instruction length to the instructions encoded in the first subset of valid fetch granule encodings, with a layout of the one or more instructions of the variable-length instruction set in the G-bit fetch granule identified by a layout descriptor encoded using the predetermined subset of bit positions of the given G-bit fetch granule

With this approach, as no valid instruction can cross a boundary between power-of-2 sized fetch granules, this can greatly simplify the complexity of the front end circuitry (and hence provide more circuit-area-efficient and power-efficient hardware), because any individual instruction can be decoded entirely from a single fetch granule. Hence, all required bits for decoding the instruction are available from a single fetch (or prefetch) cycle. There is no need for the front end circuitry to include buffering circuitry and circuit logic to stitch together parts of an instruction fetched from different fetch granules. The second subset of valid fetch granule encodings supports at least one instruction of a length not supported in a predetermined fixed-length legacy instruction set, to enable expansion of encoding space beyond that available from the predetermined fixed-length legacy instruction set. Nevertheless, the variable-length instruction set mode is fully backwards compatible with software written for the predetermined fixed-length legacy instruction set, because the variable-length instruction set mode supports the first subset of valid fetch granule encodings which simply encode instructions (e.g. power-of-2 length instructions) corresponding to the fixed-length instructions of the predetermined fixed-length instruction set. Whether a given fetch granule has been encoded according to the first or second valid fetch granule encodings can be determined from a predetermined subset of bits of the G-bit fetch granule itself (rather than needing a separate control indicator to be obtained from a control register), and so this enables compilers to mix and match fetch granules encoded with the first subset of valid fetch granule encodings and fetch granules encoded with the second subset of valid fetch granule encodings as desired, without needing to incur overhead in switching control register settings between the granules encoded using the first subset of valid fetch granule encodings and the granules encoded using the second subset of valid fetch granule encodings.

Hence, the complexity of the front end circuitry can be reduced while supporting additional encoding space (and hence a greater number of instruction types) compared to the predetermined fixed-length legacy instruction set while retaining backwards compatibility with software written according to that legacy instruction set.

The predetermined fixed-length instruction set could be any known instruction set based on fixed-length instructions, which in some examples may be fixed-length instructions each having a power-of-2 number of bits. For example, the predetermined fixed-length instruction set could be the AArch64 instruction set provided by Arm® Limited, for which each instruction has an instruction length of 32 bits.

The valid encodings for the predetermined subset of bit positions in each of the second subset of valid fetch granule encodings may be non-overlapping with valid encodings for the predetermined subset of bit positions in each of the first subset of valid fetch granule encodings. This enables the front end circuitry to distinguish whether a given G-bit fetch granule has the first or second subset of valid fetch granule encodings.

For example, in the predetermined fixed-length legacy instruction set, each valid instruction may have a given subset of bits for which one or more reserved encodings are invalid for each valid instruction representable in the predetermined fixed-length legacy instruction set. In the second subset of valid fetch granule encodings, the predetermined subset of bit positions used for the layout descriptor may comprise one or more bit portions at bit positions corresponding to the positions at which, in the first subset of valid fetch granule encodings, the given subset of bits would be encoded for at least one instruction corresponding to a fixed-length instruction of the predetermined fixed-length legacy instruction set. Each valid encoding for the layout descriptor in the second subset of valid fetch granule encodings comprises, for at least one of the one or more bit portions, one of said one or more reserved encodings that would be invalid for each valid instruction representable in the predetermined fixed-length legacy instruction set.

For example, in the AArch64 instruction set mentioned above, no valid instruction can have its upper 8 bits set to 0b0xx00001 (where xx can be any of 00, 01, 10, 11), and so in some examples the predetermined subset of bits used for the layout descriptor may include a portion of bits of the fetch granule which, for each of the first subset of valid fetch granule encodings, is used to encode the upper 8 bits of an AArch64 instruction, and in the second subset of valid fetch granule encodings that portion of bits in the layout descriptor may be encoded to have one of the reserved encodings 0b0xx00001 which is not permitted for any valid AArch64 instruction. It will be appreciated that, while this example based on AArch64 is provided for illustrative purposes, a similar principle can be applied to other legacy instruction sets which may have certain portions of instruction bits which are not permitted to take certain reserved encodings for any valid instruction of the instruction set.

The number of bits, G, in one fetch granule may be less than or equal to a number of bits in one cache line. A cache line is a data unit of a size corresponding to the granularity with which blocks of data from memory are allocated and replaced in a cache. Hence, with the encoding constraints above, there is no risk of an instruction crossing cache line boundaries, as cache lines are typically in power-of-2 byte sizes, and so the G-bit fetch granules pack with a regular alignment into each cache line. By avoiding crossing cache line boundaries, implementation of an instruction cache and instruction fetch/decoding circuitry of the front end circuitry is much simpler.

Also, as memory pages (units of memory address space sharing the same address translation mapping and/or memory access control attributes) are typically of power-of-2 byte sizes greater than the cache line size, constraining all valid instructions to be encoded entirely within a single G-bit fetch granule, with no instruction crossing a boundary between fetch granules (the fetch granules aligned to G-bit boundaries in address space), also provides the advantage that no valid instruction can cross the boundary between memory pages. This again simplifies implementation of processor hardware because it eliminates the considerable complexity which otherwise be required to deal with cases where different parts of the instructions are in different memory pages associated with different memory access permissions, or in virtual memory pages mapped by address translation mappings to non-contiguous regions of physical address space.

Some examples could permit at least one valid fetch granule encoding for which at least one instruction starts part way through a byte of the given G-bit fetch granule.

However, in some examples, the architectural encoding constraint requires that, for each instruction encoded within the G-bit fetch granule, a start of that instruction is offset from a start of the G-bit fetch granule by a power-of-2 number of bytes. This can simplify addressing of the instructions within a given fetch granule using a program counter.

In some examples, the variable-length instruction set may comprise one or more first-length instructions having a first instruction length and one or more second-length instructions having a second instruction length longer than the first instruction length. Some examples could support more than two different instruction lengths, and in that case any two of the three or more supported instruction lengths can be regarded as the first instruction length and second instruction length discussed below.

In some examples, an initial portion of each second-length instruction may have an encoding different from any valid encoding of the one or more first-length instructions. This means that the front end circuitry can uniquely identify from the encoding of a portion of the fetch granule starting at a given instruction start point whether that portion encodes the initial portion of the second-length instruction or an entire first-length instruction. Hence, there is no need for additional instruction length parameters to be encoded in the fetch granule, separate from the instructions themselves, to indicate the pattern of arrangement of first-length and second-length instructions within the fetch granule. The pattern of arrangement can be deduced from the instructions themselves.

For example, one way of encoding the instructions to distinguish the initial portion of the second-length instruction from the full encoding of the first-length instruction may be that each first-length instruction may be constrained to have at least one length field having an encoding selected from one or more predetermined encodings, and one or more bits of an initial portion of each second-length instruction, at positions corresponding to the at least one length field within the first-length instruction, may be constrained to have a different value to any of the one or more predetermined encodings. In this example, for at least one instruction layout involving a first-length instruction encoded in the G-bit fetch granule, the predetermined subset of bit positions used for the layout descriptor corresponds to bit positions used for the at least one length field within the first-length instruction.

In some examples, the first instruction length comprises a number of bits less than or equal to N bits, where N is a power-of-2 integer, and the second instruction length comprises a number of bits greater than N and less than or equal to 2N. Hence, compared to an N-bit fixed-length instruction set, the variable-length instruction set provides more encoding space because there are some supported instructions longer than N bits, but by decoding the instructions according to the architectural constraints discussed above, the longer instructions of length greater than N bits cannot cross a G-bit fetch granule and so decoding and instruction caching is simpler.

In one particular example, N=32. Many existing instruction sets use a 32-bit instruction length, but an encoding space of 2\hat{ }32 instruction encodings is starting to become strained for accommodating ever increasing demand for additional functionality. However, increasing to 64-bit instruction lengths may provide vastly more encoding space than is expected to be needed, so a fixed-length 64-bit instruction set would incur much greater hardware costs in forcing all hardware circuit implementations to incur the undesirable cost of caching, decoding and conveying instructions which are the full 64 bits wide. A variable-length instruction set supporting a first-length instruction of 32 bits or fewer and a second-length instruction of more than 32 bits helps provide a better balance, giving increased encoding space for accommodating the range of instructions expected to be needed in future, while being implementable on circuit hardware with lower circuit area and power cost than equivalent 64-bit fixed length instruction sets.

In some examples, the variable-length instruction set could support at least one non-power-of-2 length instruction in at least one of the second subset of valid fetch granule encodings of the given G-bit fetch granule. A given non-power-of-2 length instruction may have W functional bits encoding the functionality of the instruction, where W is an integer which is not an exact power of 2. For example, in the above example with first and second instruction lengths, the first instruction length could be less than N bits, and/or the second instruction length could be less than 2N bits but greater than N bits. If non-power-of-2 effective instruction lengths are used, this may mean that the instructions, when packed in the G-bit fetch granule, may leave some bits unused. These unused bits could provide room for future expansion of the instruction set, and/or could be used for encoding the layout descriptor mentioned above. Some implementations may support some of the bits of the fetch granule being defined as expansion bits which are architecturally constrained to be fixed to a particular value in a given version of the architecture, but could be converted to functional bits in later versions of the architecture to give more encoding space when needed. Those expansion bits would not need to be cached or passed along an instruction pipeline, as once the expansion bits have been checked to confirm they have the predetermined value assumed in the architecture constraint, the expansion bits can be eliminated.

However, in other examples, each instruction of the variable-length instruction set may have a power of 2 instruction length, e.g. with the first instruction length comprising N bits and the second instruction length comprising 2N bits.

In some examples, the architectural encoding constraint requires that any given instruction is represented by a contiguous portion of bits of the given G-bit fetch granule. By representing each instruction using a contiguous portion of bits from the granule, this simplifies decoding circuit logic.

However, in other examples, the architectural encoding constraint permits at least one instruction to be represented by a two or more discontiguous portions of bits of the given G-bit fetch granule. For some instruction lengths, permitting two or more discontiguously located portions of bits within the fetch granule to represent a single instruction can help with packing non-power-of-2 length instructions into the G-bit fetch granule while supporting the layout descriptor of the second subset of valid fetch granule encodings being encoded to be non-overlapping with any valid encoding for corresponding bit positions in each of the first subset of valid fetch granule encodings.

In some examples, the G-bit fetch granule is sized to fit a single instruction of a longest supported instruction length. For example, G may correspond to the smallest power of 2 that is greater than or equal to the longest supported instruction length. This can simplify the circuit logic for the front end circuitry, as it reduces the number of possible arrangements of instructions of different instruction lengths which can arise for a given fetch granule, compared to an example which permits multiple instructions of the longest supported instruction length to fit within a single fetch granule.

In some examples, for an encoding of a G-bit fetch granule that represents a plurality of instructions within a single G-bit fetch granule, the front end circuitry may support a branch operation specifying as a branch target any one of the plurality of instructions. This reduces complexity for compilers (compared to an approach where a fetch granule containing multiple instructions is treated as a single branch point with each instruction being constrained to execute in parallel, as in very long instruction word (VLIW) techniques). Hence, there is no need for the compiler to constrain selection of which instruction of a program code sequence is encoded at a particular position within the fetch granule based on expected branch target points within the program code sequence. The processing circuitry may support sequential processing of at least two of the plurality of instructions encoded within the same G-bit fetch granule. For example, it is possible for two instructions in the same G-bit fetch granule to have a memory hazard, register hazard, structural hazard, so that they cannot be processed in parallel by the processing circuitry. It is possible for some implementations to process in parallel two or more instructions within the same G-bit fetch granule provided there is no hazard between the instructions that would preclude such parallel processing. Hence, there is no need to constrain the instructions which are allowed to be encoded within the same G-bit fetch granule such that the compiler guarantees there is no hazard between the instructions encoded in the same fetch granule. The front end circuitry and/or processing circuitry may include circuitry to detect hazards between instructions, and schedule whether the instructions within a given G-bit fetch granule are processed sequentially or at least partially in parallel depending on such hazard detection.

The front end circuitry may be configured to identify instructions based on a program counter; and each of the plurality of instructions corresponds to a different encoding of the program counter. This enables each instruction within a G-bit fetch granule to act as a valid branch target for a branch operation.

The program counter may comprise a first portion of bits identifying an address of the G-bit fetch granule and a second portion of bits identifying a selected instruction of the plurality of instructions. For example, the second portion of bits may encode a byte offset indicating the start of the selected instruction relative to the start of the fetch granule, or could encode an instruction index identifying the relative order of the instruction within the fetch granule (e.g. the instruction index could run consecutively from 0 upwards for each successive instruction of the fetch granule). In practice, a byte address may be simpler to implement given the variable instruction length as it means that the memory address to fetch from is consistent for a given value of the program counter regardless of the pattern of instruction lengths packed into the same fetch granule. The address of the G-bit fetch granule may be aligned in memory to a G-bit address boundary, so that there is regular packing of G-bit fetch granules in memory address space relative to power-of-2 cache lines/page sizes. The address of the G-bit fetch granule may correspond to a program counter address for which the second portion of bits are all 0.

In some examples, even when instructions are constrained to start at integer byte offsets relative to the start of the G-bit fetch granule, the second portion of bits may provide a numeric value used to identify a corresponding instruction of the fetch granule, where that numeric value does not necessarily correspond exactly to the byte offset of the corresponding instruction. For example, if the predetermined fixed-length legacy instruction set is based on a power of 2 instruction length greater than 8 bits, one would normally expect the byte offsets represented by the lower portion of the program counter to include one or more least significant bits to always be equal to 0, and so the legacy instruction set may have reused one or more lower bits of the program counter for encoding other information (such as an instruction set identifier). However, with the second subset of valid fetch granule encodings, it is possible that some instructions could start at a non-power-of-2 byte offset relative to the start of the fetch granule (e.g. starting at offsets of 5 or 10 bytes, say). Encoding the byte offset for such non-power-of-2 values directly in the second portion might require the at least one least significant bit to be set to a value other than zero, preventing reuse of the at least one least significant bit of the program counter for other purposes if the least significant bit(s) is needed to be meaningful for a byte offset indication representing the start of the instruction in the fetch granule. To allow the legacy encoding of the least significant bit(s) of the program counter to continue to be used for encoding other information, when the fetch granule is encoded according to the second subset of valid fetch granule encodings, the front end circuitry may map a numeric value of the second portion of bits of the program counter to a byte offset indicating the start of the selected instruction according to a mapping selected based on the layout descriptor. For example, a byte offset of 5 may be represented by the second portion being 0x01xx (with xx representing other encoded information, so that any of the encodings of numeric values 4 to 7 for this second portion can be treated as a byte offset of 5). Hence, each valid encoding of the second portion of bits of the program counter does not require the least significant bit(s) of the second portion to be used to identify the byte offset, with the byte offset being identified from more significant bits of the second portion of bits, even though the valid byte offsets correspond to non-power-of-2 values that would otherwise require at least one non-zero bit at the least significant bit position(s).

The apparatus may comprise program counter advancement circuitry configured to increment the program counter from a first value corresponding to a current instruction to a second value advanced from the first value by a variable increment amount depending on an instruction length of the current instruction. The variable increment may account for the variable instruction length—e.g. if the second portion represents a byte offset the program counter may advance by a larger amount following a longer instruction and a shorter amount following a shorter instruction.

In some examples, in response to detecting an attempt to branch to a branch target corresponding to a mid-point of an instruction, the front end circuitry is configured to trigger a corrective action. With the variable instruction length, there becomes a possibility of a given program counter value specified as a branch target address mapping to a mid-point of a longer instruction. The encoding of the instruction set may be designed to allow this to be detected (e.g. by the upper part of a longer instruction having an encoding which is invalid for any shorter instruction, or based on pre-decode information pre-decoded from the layout descriptor). Hence, if a branch to a mid-point of an instruction is detected, a corrective action can be taken to avoid proceeding based on an invalidly encoded fetch granule.

For example, the corrective action may comprises signalling an exception.

The apparatus may comprise an instruction cache configured to cache instructions fetched from a memory system; and pre-decoding circuitry configured to pre-decode a given G-bit fetch granule fetched from the memory system and allocate one or more instructions to the instruction cache based on pre-decoding the given G-bit fetch granule. While pre-decoding circuitry is not essential, and some micro-architectures could rely solely on decoding logic which operates after instructions are fetched from the instruction cache, not before instructions are allocated into the instruction cache, pre-decoding circuitry can help simplify the subsequent decode logic, because, for example, the relative arrangement of instructions within a G-bit fetch granule can be identified at the pre-decode stage and indicated in the cache so that the start points of each instruction are already known at the point when instructions are actually fetched for processing. This can improve meeting circuit timings because the overhead and latency associated with decoding the relative position of instructions within the fetch granule is incurred off the critical path, at the time of caching instructions, rather than when the instructions actually need to be executed.

For example, the front end circuitry may be configured to control instruction fetching based on pre-decode information generated by the pre-decoding circuitry and cached in the instruction cache, with the pre-decode information for the given G-bit fetch granule indicating at least one of: a layout of instructions within the given G-bit fetch granule as identified based on the layout descriptor; a length of each instruction decoded from the given G-bit fetch granule; and valid branch targets corresponding to the G-bit fetch granule. This enables, for example, more efficient implementation of detection of a branch to a mid-point of an instruction, since pre-decode information summarising the instruction layout in the granule, the valid branch points, and/or particular instruction lengths can be used to detect whether the corrective action is needed, rather than needing a full decoding of a fetch granule at the time of the fetch corresponding to the branch target.

The variable-length instruction set mode may not be the only instruction set mode supported by the apparatus. In some examples, the front end circuitry may also support at least one further instruction set mode for which instructions to be processed are not required to satisfy said architectural encoding constraint used in the variable-length instruction set mode. For example, the at least one further instruction set mode may be a mode for supporting a legacy instruction set used for software written prior to the introduction of the variable-length instruction set supported in the variable-length instruction set mode.

Specific examples are now described with reference to the drawings.

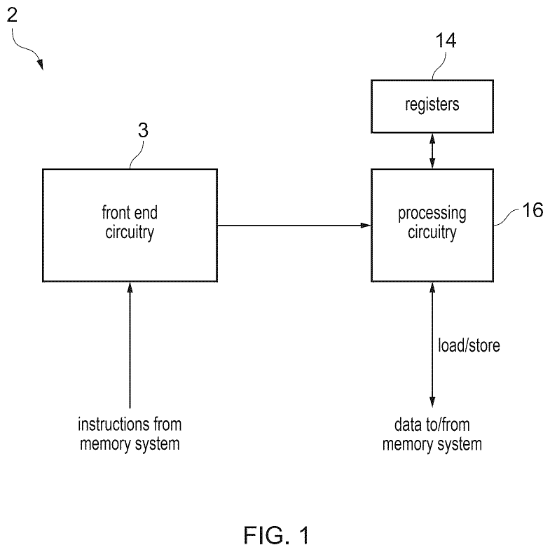

FIG. 1 schematically illustrates an example of a data processing apparatus 2 having front end circuitry 3 and processing circuitry 16. The front end circuitry 3 is responsible for fetching instructions from a memory system or instruction cache and decoding the instructions to generate micro-operations ready for processing by the processing circuitry (the micro-operations representing the decoded form of the instruction). Optionally, the front end circuitry 3 may also perform pre-decoding of instructions prior to caching in the instruction cache, so that pre-decode information can be derived from an instruction loaded from the memory system and the pre-decode information can be cached along with the instruction in the instruction cache. This enables the power cost of performing some decoding steps to be incurred once when the instruction is cached rather than multiple times when the same cached instruction is fetched multiple times for execution (e.g. when the instruction appears within a program loop to be iterated multiple times).

The processing circuitry 16 comprises execution units for executing different classes of processing operation corresponding to the micro-operations generated by the front end circuitry 3 (e.g. the classes of instructions may include load/store instructions, arithmetic/logical instructions, branch instructions, etc.). Registers 14 are provided to store operands for the operations performed by the processing circuitry 16. Results of processing operations can be written to the registers 14.

An instruction set architecture (ISA) defines the format with which each instruction is encoded to represent the functionality to be performed by the processing circuitry 16 in response to the instruction being fetched, decoded and issued for processing by the front end circuitry 3. The ISA may define an instruction set representing the set of instruction types to be supported by the front end circuitry 3 and processing circuitry 16, and for each instruction in the instruction set, the ISA defines an encoding format which sets out the various fields of the instruction encoding that represent an opcode (identifying instruction type) and other instruction parameters including, if applicable, a destination register specifier identifying a destination register to which a result of the instruction should be written, one or more source register specifiers and/or immediate values identifying source operands for the processing operation represented by the instruction, and any other parameters which may influence how the instruction is processed by the processing circuitry 16.

A common instruction length in use in many processor architectures is 32 bits, which provides encoding space for 2\hat{ }32 different instruction encodings. However, over time a 32-bit instruction encoding may become strained, as there may be constant pressure to accommodate new instructions being added as part of regular extensions to the architecture. One solution to this problem is to define a variable-length instruction set such that existing instructions can remain at a shorter length (e.g. 32 bits) and new instructions could be added using a longer instruction length (e.g. 64-bit encodings).

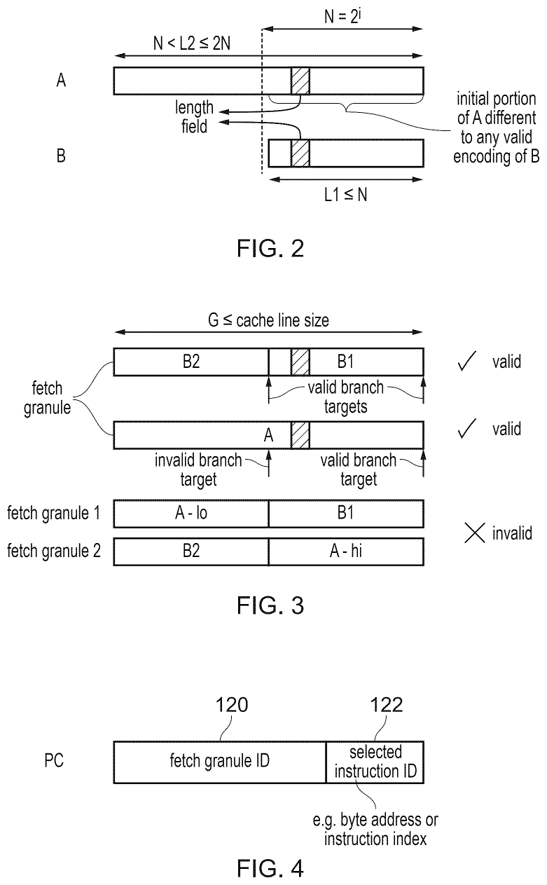

FIG. 2 illustrates a first example of instruction encodings according to a variable-length instruction set to be processed in variable-length instruction set mode supported by the front end circuitry 3 and the processing circuitry 16. It will be appreciated that this may not be the only instruction set mode supported, and in other modes the front-end circuitry 3 and processing circuitry 16 may process instructions according to a different encoding scheme.

In the variable-length instruction set example of FIG. 2, the supported instructions includes a first class of L1-bit instructions “B” with a shorter instruction length L1 and a second class of L2-bit instructions “A” with a longer instruction length L2. L1≤N, where N is a power of 2 such that N=2\hat{ }i, where i is a positive integer. N<L2≤2N, so L2 is greater than one power of 2 but less than or equal to the next power of 2. In one particular example, L1=32 and L2=64, but it is also possible for instruction lengths to be used with a number of functional bits which is not an exact power of 2, which when packed into power-of-2 sized fetch granules as discussed further below may leave some bits spare to accommodate future expansion of the instruction set.

The initial portion (e.g. bottom N bits) of the L2-bit instructions may have a different encoding to any valid encoding of a L1-bit instruction. For example, one or more length fields may be provided at certain designated bit positions at corresponding positions in the L1-bit instruction and the lower part of the L2-bit instruction, which are constrained to specify different values for L1-bit and L2-bit instructions respectively.

FIG. 3 schematically illustrates encoding constraints required to be satisfied for valid instructions defined according to the variable-length instruction set. A given instruction is assumed by the front end circuitry 3 to meet an encoding constraint in which the given instruction is encoded fully within a G-bit fetch granule, where G is a fixed power-of-2 integer; no valid instruction is allowed to cross a boundary between G-bit fetch granules; and the given instruction is represented by a contiguous portion of bits of the given G-bit fetch granule. The fetch granule size G may be less than or equal to the size of a cache line (the unit of data transferred between memory and a cache in one transfer).

In this example, a G-bit fetch granule is sized to accommodate a single instruction of the longest supported instruction length, in this example the length L2 associated with the “A” instructions from FIG. 2. In FIG. 3, for ease of explanation, it is assumed that the “A” instructions have L2=2N bits and the “B” instructions have L1=N bits, where N is a power of 2. Therefore, to accommodate a 2N-bit instruction within a fixed power-of-2 sized fetch granule, G=2N. However, it will be appreciated that in other examples L1 and L2 could be a non-power-of-2 number of bits within the bounds shown in FIG. 2. In that case, the granule size G can still be 2N bits, and the start position of each instruction within a fetch granule can still be aligned to an N-bit boundary, such that the valid branch target positions (addresses to which a branch can direct the program flow) are still the same as in FIG. 3, but there could be some unused bits at most significant end of each instruction.

Hence, the first example shows a valid encoding where two instructions B1, B2 of the shorter length L1 are packed into the same fetch granule. Each of these instructions can be a valid branch target for a branch operation (and corresponds to a different encoding of a program counter as discussed further below with respect to FIG. 4).

The second example in FIG. 3 shows another valid encoding, in which a single instruction A of the longer length L2 is provided by the G-bit fetch granule. In this case, only the start of the instruction is a valid branch target, and a mid-point of the instruction (corresponding to the address at which the second instruction B2 would have started had the fetch granule been encoded as in the first example) is an invalid branch target. The front end circuitry 3 can detect from the length field or other information in the initial portion of the L2-bit “A” instruction that the midpoint will be an invalid branch target, so that a corrective action can be performed if there is an attempt to branch to this midpoint address. For example, during allocation of instructions into an instruction cache, pre-decoding circuitry of the front end circuitry 3 can decode the length field of each instruction to generate pre-decode information specifying the valid branch points, which can be used, when attempting to fetch instructions from a given branch target address, to determine whether that branch target address is valid, and hence whether a corrective action (e.g. signalling an exception) is to be performed.

The third example in FIG. 3 shows an invalid encoding, in which the first instruction in a first fetch granule is an L1-bit instruction B1, followed by an L2-bit instruction A which spans the boundary from the first fetch granule to a second fetch granule and another L1-bit instruction B2 in the remaining part of the second fetch granule. This encoding is prohibited by the ISA supported by the front end circuitry 3 and processing circuitry 16. Therefore, the hardware designer of the front end circuitry 3 can design the front end circuitry 3 with simpler circuit logic, as it can be assumed that any valid instructions take one of the first two example encodings, so the front end circuitry 3 does not need buffering circuitry to buffer a first portion A-lo of the L2-bit instruction A from one fetch granule while awaiting another fetch granule to be fetched with the remaining portion A-hi of the instruction. Therefore, if the user happens to supply program code where the instructions are incorrectly aligned with an “A” instruction crossing a fetch granule boundary, this may risk unpredictable and incorrect results as attempting to decode the lower portion A-lo of the “A” instruction as a shorter L1-bit “B” instruction may give the wrong result. In contrast, typical existing variable length instruction sets do permit an instruction to be unaligned to a memory address boundary corresponding to the longest supported instruction size (so that the third example encoding would be valid), which means that to ensure that the architecturally defined results of a long “A” instruction crossing a fetch granule boundary, it would be needed to use more complex decode logic supporting extra buffering of partial instructions and more complex instruction cache linefill mechanisms to allow an instruction to be assembled from bits taken from multiple cache lines. By prohibiting such crossing of fetch granule boundaries, it can be enforced that each instruction is decodable from only a single cache line, which greatly simplifies pre-decoding, decoding and instruction cache implementation.

A consequence of prohibiting an instruction from crossing a fetch granule boundary is that, if the program sequence desired to be executed is such that the first instruction in a given fetch granule is to be the shorter L1-bit instruction B1, but the next instruction in the program to be executed is a longer L2-bit instruction A, then the given fetch granule would need to be padded out with a no-operation (NOP) instruction of the L1-bit instruction class (i.e. the position B2 shown in FIG. 3 would represent the NOP), so that the next “A” instruction can start in the next fetch granule. The NOP instruction is an instruction which does not require any operation to be performed other than advancing a program counter to the next instruction of the program. While the additional NOP instruction slightly reduces code density in memory, the NOP instruction can typically be eliminated relatively early in a processing pipeline, to avoid consuming instruction slots that could be used for other instructions.

While FIGS. 2 and 3 show examples supporting only two different instruction lengths L1 and L2, other examples could support more than two instruction lengths (e.g. with 16-bit, 32-bit and 64-bit instructions, allowing additional packing patterns within a G-bit fetch granule beyond the two alternatives shown for the L1/L2 example of FIG. 3). Also, some examples could have a fetch granule size G more than two times the shortest supported instruction length, so could accommodate more than two instructions of that shortest length into one fetch granule.

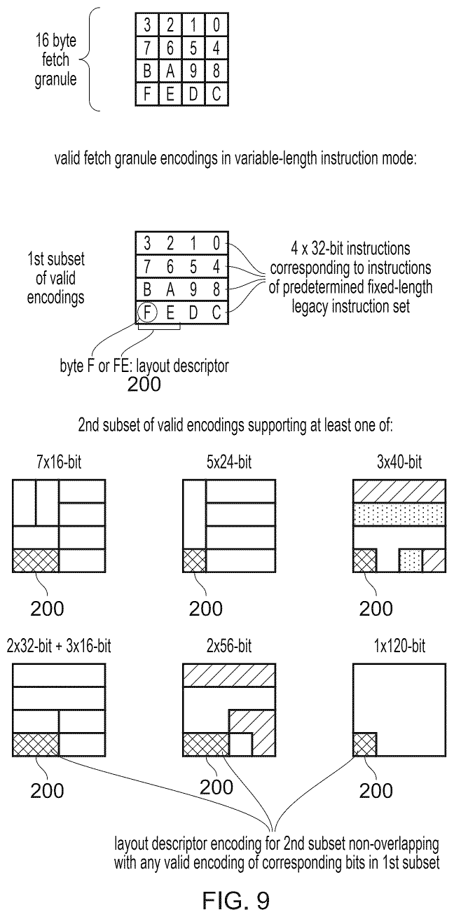

In this example, each instruction is encoded using a contiguous portion of bits within the fetch granule, but as shown in a further example described with reference to FIG. 9 below, this is not essential.

The shorter L1-bit instructions B1, B2 may be encoded to correspond with fixed-length instructions supported in a predetermined fixed-length legacy instruction set. For example, the L1-bit instructions may be 32-bit instructions supported in the AArch 64 instruction set provided by Arm® Limited. Hence, the first example encoding in FIG. 3, which encodes two 32-bit instructions B1, B2 in the fetch granule, is an example of an encoding according to a first subset of valid fetch granule encodings, for which two or more instructions are encoded in the fetch granule corresponding to fixed-length instructions from a predetermined fixed-length legacy instruction set. If the apparatus 2 executes legacy software written according to the predetermined fixed-length legacy instruction set, the program instructions supplied to the front end circuitry 3 from memory would be encoded such that every fetch granule is encoded according one of these first subset of valid fetch granule encodings, with each 64-bit fetch granule comprising 2 32-bit legacy instructions. Therefore, the variable-length instruction set mode can be fully backwards compatible with software written for the legacy instruction set.

On the other hand, the second encoding in FIG. 3 with the fetch granule comprising a single “A” instruction of length L2 is an example of an encoding according to a second subset of valid fetch granule encodings, for which the given G-bit fetch granule encodes one or more instructions of the variable-length instruction set, including at least one instruction with a different instruction length to the instructions encoded in the first subset of valid fetch granule encodings. A layout of the one or more instructions of the variable-length instruction set in the G-bit fetch granule identified by a layout descriptor encoded using the predetermined subset of bit positions of the given G-bit fetch granule. The layout descriptor in this example corresponds to the length field shown in FIG. 2, which is encoded such that all valid encodings for the length field in the second subset of valid fetch granule encodings are non-overlapping with all valid encodings for the length field in the first subset of valid fetch granule encodings. For example, where the legacy instruction set is AArch 64 then, within each 32-bit instruction represented by bits [31:0], bits [29:25] cannot be 0b00001 for any valid AArch 64 instruction, and so the length field could correspond to at least bits [29:25] of the lower half of the fetch granule, which if set to 0b00001 identify the second subset of valid fetch granule encodings comprising a single “A” instruction of length L2. The encoding scheme for the “A” instructions may be such that bits [29:25] of the “A” instruction are constrained to be 0b00001 for all the longer L2-bit instructions.

For software written to use at least one instruction of the new instruction length not previously supported in the predetermined fixed-length legacy instruction set, the compiler can mix and match fetch granules encoded according to the first subset of encodings and fetch granules encoded according to the second subset of encodings. Since the layout descriptor (e.g. length field) encoded in each fetch granule can be used to fully disambiguate which subset of encodings is being used, there is no need to switch control information in a control register when switching between the legacy encoded instructions and the newer supported instructions, which can enable compilers to reuse portions of old software when possible but exploit newer instructions for small pockets of compiled code, without any overhead of additional instructions for switching instruction sets.

FIG. 4 shows an example encoding of the program counter (PC) representing a given instruction (or, equivalently, a given branch target point) within a sequence of instructions to be executed. The program counter may comprise a first portion 120 and a second portion 122. The first portion 120 comprises fetch granule identifying bits which represent an address of the G-bit fetch granule that contains the instruction represented by the program counter. The second portion 122 comprises instruction identifying bits which distinguish each individual instruction within a given fetch granule. The address indicated in the first portion 120 may be considered to point to the least significant byte of the G-bit fetch granule. The second portion 122 may be 0 for the first instruction in the fetch granule. For example, with G=64 (8-byte fetch granules), the 8-byte aligned address would have its lower 3 bits all set to 0, so the second portion 122 may be represented by bits [2:0] of the program counter and the first portion by bit [3] onwards. This allows up to 8 valid branch target points to be encoded within the fetch granule, using the second portion 122 of the PC. The sub-granule instruction identifier bits within the second portion 122 can be encoded in a number of different ways. In one example, the position of a given instruction is encoded using a byte address which indicates which byte of the fetch granule contains the first bit of the corresponding instruction. Hence, the PC value for a given instruction is simply the byte address of the location in memory at which that instruction's first bit is stored. Another approach to encoding the second portion 122 can be to specify an instruction index in the second portion, which runs consecutively from 0 upwards for each successive instruction of the fetch granule. With this approach, the instruction index values for the instructions B1, B2 shown in the first example of FIG. 3 could be 0, 1 respectively. It will be appreciated that other encodings are also possible. For example, the value of the second portion 122 can be mapped to a byte address identify the byte offset where the corresponding starts, according to a mapping selected based on a layout descriptor encoded in part of the fetch granule (such as the length field mentioned above).

Regardless of whether a byte address, instruction index, or other encoding is used for the second portion 122, if the supported instruction lengths are such that the maximum number of instructions per fetch granule is less than the number of encodings of the second portion 122 (e.g. in the example of FIG. 3 the maximum number of instructions per fetch granule is 2 but with 8 byte fetch granules the second portion 122 supports 8 encodings), then there may be some spare encodings of the second portion 122 which could be reused to signal other information. For example, a bit of the second portion 122 could indicate a hint about which instruction set mode is being processed, to enable more efficient transitions of instruction set mode which can be detected automatically from a transition of the instruction set mode bit of the PC rather than needing explicit instructions for setting the instruction set mode.

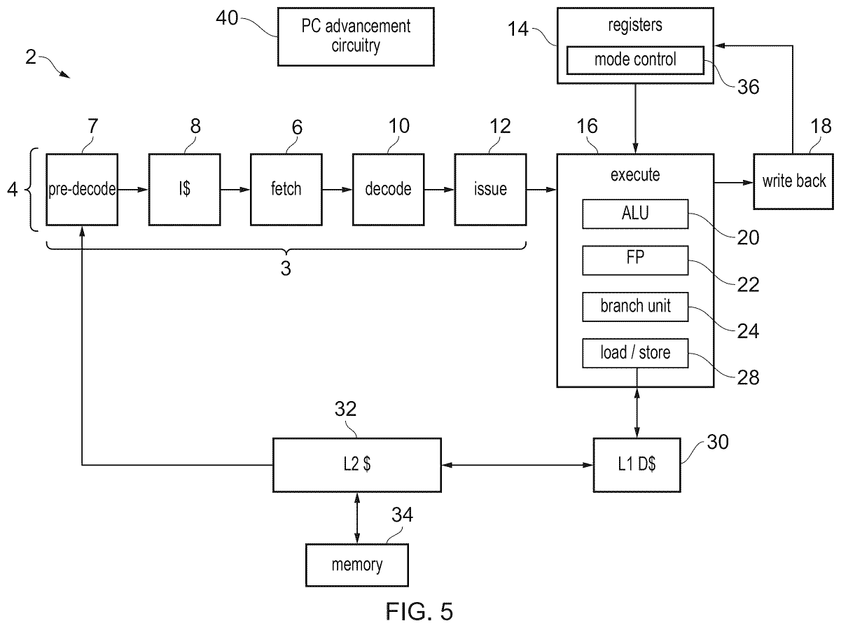

FIG. 5 schematically illustrates an example of the data processing apparatus 2, showing in more detail components of the front end circuitry 3 and processing circuitry 16. The data processing apparatus has a processing pipeline 4 which includes a number of pipeline stages. It will be appreciated that this is merely one example of possible pipeline architecture, and other systems may have additional stages or a different configuration of stages.

In this example, the pipeline stages include a pre-decode stage 7 for pre-decoding instructions obtained from a memory system; an instruction cache 8 for caching the pre-decoded instructions; a fetch stage 6 for fetching instructions from the instruction cache 8; a decode stage 10 for decoding the fetched program instructions to generate micro-operations (decoded instructions) to be processed by remaining stages of the pipeline; and an issue stage 12 for checking whether operands required for the micro-operations are available in a register file 14 and issuing micro-operations for execution once the required operands for a given micro-operation are available (or are guaranteed to become available by the time the micro-operation reaches the relevant point at which the operand is needed for execution of the micro-operation). In some examples, there may be a one-to-one relationship between program instructions decoded by the decode stage 10 and the corresponding micro-operations processed by the execute stage. It is also possible for there to be a one-to-many or many-to-one relationship between program instructions and micro-operations, so that, for example, a single program instruction may be split into two or more micro-operations, or two or more program instructions may be fused to be processed as a single micro-operation. The pre-decode stage 7, fetch stage 6, decode stage 10 and issue stage 12 may collectively be considered to correspond to the front end circuitry 3 described earlier. In some examples the front end stages could also include a register renaming stage for mapping architectural registers specified by program instructions or micro-operations to physical register specifiers identifying physical registers in the register file 14.

The pipeline 4 also has an execute stage 16 (corresponding to the processing circuitry mentioned earlier) for executing data processing operations corresponding to the decoded/issued micro-operations, by processing operands read from the register file 14 to generate result values; and a writeback stage 18 for writing the results of the processing back to the register file 14. The execute stage 16 includes various execution units for executing different classes of processing operation. For example the execution units may include an arithmetic/logic unit (ALU) 20 for performing arithmetic or logical operations, a floating-point unit 22 for performing operations on floating-point values, a branch unit 24 for evaluating the outcome of branch operations and adjusting the program counter which represents the current point of execution accordingly, and a load/store unit 28 for performing load/store operations to access data in a memory system. In this example the memory system include a level one data cache 30, a shared level two cache 32 and main system memory 34. It will be appreciated that this is just one example of a possible memory hierarchy and other arrangements of caches can be provided. The specific types of execution unit 20 to 28 shown in the execute stage 16 are just one example, and other implementations may have a different set of execution units or could include multiple instances of the same type of execution unit so that multiple micro-operations of the same type can be handled in parallel. It will be appreciated that FIG. 1 is merely a simplified representation of some components of a possible processor pipeline architecture, and the processor may include many other elements not illustrated for conciseness, such as branch prediction mechanisms or address translation or memory management mechanisms.

Hence, when implementing the variable-length instruction set having instructions encoded as shown in FIGS. 2 and 3, in at least one mode of operation (a variable-length instruction set mode), the front end circuitry (e.g. pre-decode circuitry 7 and/or decode circuitry 10) decodes the instructions according to an encoding scheme where each instruction is required to meet an architectural encoding constraint that requires that the given instruction is encoded fully within a G-bit fetch granule, where G is a fixed power-of-2 integer, and no valid instruction is allowed to cross a boundary between G-bit fetch granules. As discussed above, the valid encodings for a fetch granule support the first subset of valid fetch granule encodings (enabling backwards compatibility with a fixed-length legacy instruction set) and the second subset of valid fetch granule encodings (providing at least one additional instruction of an instruction length not supported in the legacy instruction set), with a layout descriptor positioned at a predetermined subset of bits within the fetch granule distinguishing whether that fetch granule is encoded according to the first or second subset of valid fetch granule encodings. Each instruction in the fetch granule has a corresponding program counter value, so can act as a valid branch target. However, the longer instructions span multiple potential branch target locations which can be designated by the PC, so mid-points of those instructions are treated as invalid instructions if branched to. The front end circuitry 3 signals an exception if there is an attempt by the fetch stage 6 to fetch for processing an instruction from a PC address that corresponds to the mid-point of an instruction. This can be detected based on pre-decode information generated by the pre-decode circuitry 7 (derived from length information encoded in the instructions of a given fetch granule) at the time of allocating instructions into the instruction cache 8, even if a synchronous exception based on the branch to the invalid branch point is not raised until there is an attempt to fetch an instruction for which the pre-decode information indicates that the PC value specified as the branch target address would be an invalid branch target).

The variable-length instruction set mode may not be the only instruction set mode supported by the apparatus 2. The registers 14 may include at least one control register storing a mode control value 36 which specifies a current instruction set mode. The instruction set mode may influence the encoding scheme with which instructions are assumed to be defined when fetched from memory, and hence the way in which those instructions are decoded by the front end. In some cases, at least one legacy instruction set mode may also be supported, enabling the same apparatus 2 to handle both software written according to a legacy instruction set not having the encoding constraints discussed for the variable-length instruction set, and the variable-length instruction set discussed above. The mode control value 36 in the registers 14 may be updated based on instructions executed by the processing circuitry 2, e.g. by executing a system register updating instruction, or alternatively could be updated by detecting, based on spare bits in a program counter used to track program flow, which instruction set a given instruction at a given program counter address belongs to, so that if there is a transition from one instruction set to another, this can be detected from a change in the instruction set indicating bits of the program counter when carrying out a branch to a branch target corresponding to a specified value of the program counter. Hence, there are a variety of ways in which multiple instruction sets could be supported in a modal manner within the same hardware platform. However, it will be appreciated that there is no need to switch the state of the mode control value 36 when switching between a fetch granule encoded using the first subset of valid fetch granule encodings and a fetch granule encoded using the second subset of valid fetch granule encodings, as the layout descriptor encoded in the fetch granule itself enables these to be distinguished. Hence, the first and second subsets of valid fetch granule encodings can both be supported for a given setting of the mode control value 36.

As shown in FIG. 5, the apparatus may also have program counter advancement circuitry 40 for maintaining the program counter (PC) that tracks the current point of program flow reached by an executed program. Although FIG. 5 for conciseness shows a single instance of PC advancement circuitry 40, in practice the pipelined processing of instructions by the apparatus 2 means that while a later pipeline stage (e.g. the execute stage 16) is processing an older instruction from an earlier point of program flow, an earlier pipeline stage (e.g. the fetch stage 6) may be processing a younger instruction from a later point of program flow. Therefore, in some examples respective pipeline stages (e.g. the fetch 6 and execute stages 16) may maintain their own versions of a program counter which store values offset from one another based on the depth of the pipeline. Hence, references to PC advancement circuitry 40 below may refer to any of one or more instances of PC advancement circuitry 40 that may be present in the system.

A given instance of PC advancement circuitry 40 may, for sequences of instructions that do not involve any taken branch, advance the program counter sequentially to track progression of program flow sequentially from one instruction to the next. When a branch is taken, the program counter address may be updated non-sequentially based on the branch target address of the branch operation. The amount by which the program counter address is updated from one instruction to the next in a non-branching program flow may be variable, depending on the instruction alignment pattern. For example, if the PC is encoded using a byte offset for the second portion 122, then if a fetch granule is encoded with instructions B1, B2 as in the first example of FIG. 3, the program counter address may be advanced by N/8 bytes per instruction, while if a fetch granule is encoded with an instruction A as in the second example of FIG. 3, the program counter address may be advanced by 2N/8 bytes per instruction. In other examples with irregular instruction layout patterns within the fetch granule (e.g. as shown in FIG. 9), the PC advancement circuitry may comprise circuit logic implemented in hardware which defines a state machine by which the next PC value can be selected as a function of the previous PC value according to a state machine function which may be variable depending on the layout descriptor obtained from the corresponding G-bit fetch granule.

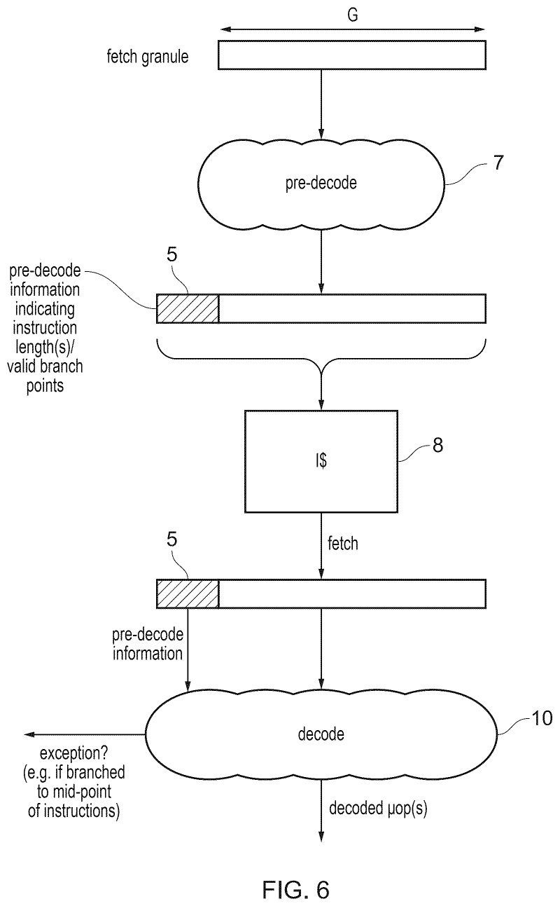

FIG. 6 illustrates an example of the front end circuitry 3 for handling instructions encoded according to the variable-length instruction set mode. The front end circuitry 3 comprises pre-decode circuitry 7, an instruction cache 8, and decode circuitry 10 (and instruction fetch circuitry 6 which is not explicitly indicated in FIG. 6). On an instruction cache linefill (triggered either by a demand fetch request generated by the front end circuitry 3 when an instruction actually needs to be fetched for decoding and execution by the processing circuitry 16, or by a prefetch request to prefetch instructions into the instruction cache 8 in advance of the time when the instruction actually needs to be executed), the pre-decode circuitry 7 pre-decodes a cache line comprising one or more G-bit fetch granules, to identify one or more properties of the instructions encoded in those fetch granules, and generates pre-decode information 5 representing the identified properties of those instructions. For example, the pre-decode circuitry 7 may decode the layout descriptor(s) of the one or more G-bit fetch granules to identify the instruction lengths and positions at which each instruction is encoded in the cache line and hence the valid branch target points to which a branch may validly be performed. The pre-decode information indicating the instruction layout, length of each instruction and/or the valid branch points is cached in the instruction cache 8 along with the instructions themselves.

On fetching a given instruction from the instruction cache 8, the front end circuitry 3 (e.g. fetch circuitry 6) obtains the functional bits of that instruction and any associated pre-decode information 5 obtained from the instruction cache 8, and supplies this to the decode circuitry 10, which identifies based on the pre-decode information 5 whether an exception or other corrective action (e.g. treating the instruction as a NOP) should be signalled. For example, if the pre-decode information 5 specifies that the PC value for which the fetch was attempted corresponds to an invalid branch point corresponding to a midpoint of a longer instruction, then the corrective action can be taken. If the corrective action is not needed, then one or more micro-operations are generated by the decode circuitry 10 based on the fetched instruction, and supplied to the processing circuitry 16 for execution.

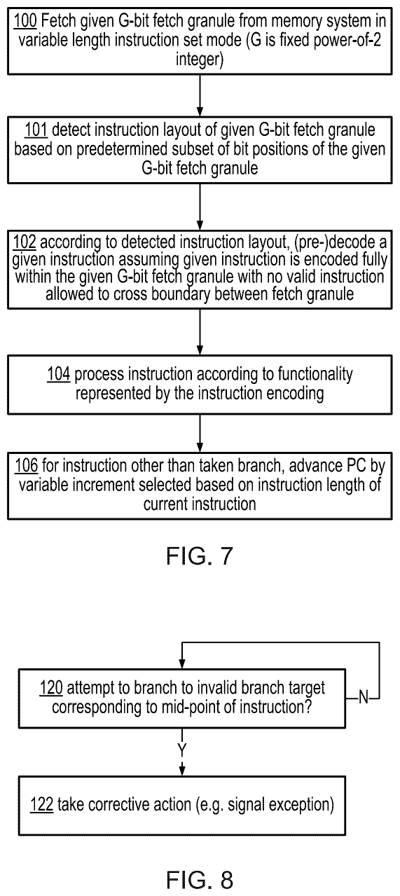

FIG. 7 illustrates a method of processing instructions according to a variable length instruction set mode. At step 100, a given G-bit fetch granule is fetched from a memory system in a variable length instruction set mode. G is a fixed power-of-2 integer. At step 101, the front end circuitry 3 detects an instruction layout of the given G-bit fetch granule based on a predetermined subset of bit positions of the given G-bit fetch granule which are used to encode a layout descriptor for the fetch granule. At step 102, the front end circuitry 3 decodes (or pre-decodes), according to the detected instruction layout, a given instruction from the fetch granule assuming that instruction is encoded fully within a fetch granule, with no valid instruction allowed to cross boundary between fetch granules. At step 104, the instruction is processed according to the functionality represented by its encoding. At step 106, for an instruction other than a taken branch, the program counter advancement circuitry 40 advances the program counter by a variable increment selected based on the instruction length of the current instruction.

FIG. 8 illustrates steps for detecting invalid branch target points. At step 120, the front end circuitry 3 detects whether there is an attempt to branch to an invalid branch target corresponding to the midpoint of an instruction. This can be detected, for example, based on pre-decode information 5 cached in the instruction cache 8, which is derived during a cache linefill from the layout descriptor encoded within a given fetch granule. If an attempt to branch to an invalid branch target is detected, then at step 122, a corrective action is triggered, such as signalling an exception. This is not needed if the branch target is valid and corresponds to the start of an instruction.

FIG. 9 illustrates another example of encoding fetch granules according to the variable length instruction mode discussed above. In this example, the fetch granule is a 16-byte fetch granule, comprising bytes labelled 0, 1, . . . , E, F to represent byte positions at byte offsets 0 to 15 relative to the address of the start of the fetch granule. For ease of representing the instruction layouts, the fetch granule is graphically represented as a square grid in FIG. 9 with four rows of bytes labelled 0-3, 4-7, 8-B, C-F, but it will be appreciated that this is just a schematic representation and in practice each byte position indicated simply corresponds to a byte of data obtained from a memory system location corresponding to a given byte address in the memory address space. The fetch granule could equally have been represented in a linear form with the bytes in a line from 0 to F.

In a first subset of valid fetch granule encodings, the fetch granule represents 4 32-bit fixed-length instructions corresponding to instructions of a predetermined fixed-length legacy instruction set, such as AArch64. The four instructions are represented by bytes [0,1,2,3], [4,5,6,7], [8,9,A, B] and [C, D, E, F] respectively. The fetch granule is fully packed with power-of-2 length instructions, with no spare bits. Hence, there is a regular alignment of the instructions at intervals of 4 bytes, and the program counter (PC) may be encoded with the second portion 122 having the same encoding that it would have had for software encoded in the legacy instruction set (e.g. with the third and fourth least significant PC bits, when left shifted by two bit positions, representing the byte offset of the corresponding instruction - the least significant two PC bits are reused for other information and so are not meaningful to identifying which instruction is represented by the PC).

Hence, the variable length instruction set supported in the variable length instruction mode is a superset of the predetermined fixed-length legacy instruction set, in that all existing instructions of the legacy instruction set continue to be supported, but the variable length instruction set also supports additional encodings according to a second subset of valid fetch granule encodings. For the second subset of valid fetch granule encodings, the variable length instruction set supports at least one additional instruction with a length not supported in the legacy instruction set (e.g. with a length other than 32 bits).

FIG. 9 illustrates six different example instruction layouts which can be supported for the fetch granule when encoded according to one of the second subset of valid fetch granule encodings. It is not essential for the variable length-instruction set mode to support each of these instruction layouts. A given implementation of the variable length-instruction set mode can support any one or more of these instruction layouts (or could support other examples of instruction layouts not indicated in FIG. 9 but based on similar principles to expand the range of instruction lengths and encodings supported in the variable length-instruction set beyond that supported in the legacy instruction set). It will be appreciated that, even among the particular layouts shown in the examples of FIG. 9, the particular byte positions used to represent each instruction could be varied (e.g. the bytes 0 to D in the 7×16-bit layout could have been partitioned in a different way to represent the 7 16-bit instructions).

The six examples shown in FIG. 9 include:
7×16-bit layout: 7 16-bit instructions are encoded in bytes [0] to [D] (in this particular example, with the instructions represented by byte positions [0,1], [4,5], [2,6], [3,7], [8,9], [A, B] and [C, D] respectively), leaving two bytes [E, F] spare to act as the layout descriptor 200.
5×24-bit layout: 5 24-bit instructions are encoded in bytes [0] to [E] (in this particular example, with the instructions represented by byte positions [0,1,2], [4,5,6], [8,9,A], [3,7,B], [C, D, E] respectively), leaving one byte [F] spare to act as the layout descriptor 200.
3×40-bit layout: 3 40-bit instructions are encoded in bytes [0] to [E] (in this particular example, with the instructions represented by byte positions [0,1,2,3,C], [4,5,6,7,D], [8,9,A, B, E] respectively), leaving one byte [F] spare to act as the layout descriptor 200.
2×56-bit layout: 2 56-bit instructions are encoded in bytes [0] to [D] (in this particular example, with the instructions represented by byte positions [0,1,2,3,8,9,C] and [4,5,6,7,A, B, D] respectively), leaving two bytes [E, F] spare to act as the layout descriptor 200.
1×120-bit layout: a single 120-bit instruction is encoded in bytes [0] to [E], leaving one byte [F] spare to act as the layout descriptor 200.
2×32-bit+3×16-bit layout: two 32-bit instructions (e.g. having legacy encodings from the

fixed-length legacy instruction set) are encoded, in this example using byte positions [0,1,2,3] and [4,5,6,7], and three further 16-bit instructions having new encodings not supported in the legacy instruction set are also encoded in the same fetch granule, in this example using byte positions [8,9], [A, B] and [C, D] respectively, leaving two bytes [E, F] spare to act as the layout descriptor 200.

Note that these examples demonstrate that it is not essential for each instruction to be represented by a contiguous set of bytes in the fetch granule. For example, the 3×40-bit and 2×56-bit layouts include instructions represented by two or more discontiguous portions of bits within the fetch granule (that is, the instruction is represented by a combination of bits in two or more bytes which are separated in the memory address space by at least one intervening byte not used to encode any part of that instruction). Also, these examples show it is not essential for all instructions within the fetch granule to have the same instruction length. The 2×32-bit+3×16-bit layout is an example of a mixed-length instruction layout including, within the same fetch granule, instructions of two or more different instruction lengths.

The layout descriptor 200 for each of the second subset of valid fetch granule encodings is represented in this example by either byte [F] alone, or bytes [E,F] together. Whether the second byte [E] is needed may depend on how many spare reserved encodings are available which are invalid for the most significant one or two bytes of each valid instruction in the legacy instruction set, and on how many of the alternative layouts for the second subset of valid encodings are to be supported.

For example, if the legacy instruction set is AArch 64, the upper byte of each 32-bit instruction in the legacy instruction set cannot take values 0b0xx00001, which leaves four spare encodings for byte F of the fetch granule. Hence, by using byte [F] alone as the layout descriptor 200, this could support up to four of the additional instruction layouts for the second subset of valid encodings (e.g. selecting 4 of the 6 options shown in FIG. 9). The layout descriptor 200 for those additional instruction layouts is constrained to take the value 0b0xx00001 with the values of the bits marked x identifying which of the four layouts is represented for a given fetch granule. For those instruction layouts which do not use byte [E] to encode any part of a valid instruction, byte [E] is essentially spare and could be used for encoding other information or reserved for possible future expansion.

On the other hand, if the number of additional layouts to be supported for the second subset of valid fetch granule encodings is greater than 4, then byte [E] could be used as an additional byte for the layout descriptor 200. Hence, as the upper two bytes of any valid 32-bit instruction in the legacy instruction set are constrained to have value other than 0b0xx00001xxxxxxxx, all valid encodings of the second subset of valid fetch granule encodings have this encoding 0b0xx00001xxxxxxxx for bytes [F, E], with the bits marked x providing 10 bits of encoding space that can be used to distinguish the different instruction layouts supported for the second subset of valid fetch granule encodings and/or instruction encodings in example layouts requiring bit [E] for part of a valid instruction. In practice, the number of supported instruction layouts is likely to be much less than 2\hat{ }10, so there can be additional bits spare which could be reused for other purposes or reserved for future expansion of the instruction set. If some of the supported instruction layouts (e.g. the 5×24-bit, 3×40-bit or 1×120-bit examples discussed above) require byte [E] to be used to represent part of a valid instruction, then the encodings of the layout descriptor 200 and for the valid instructions in each of the instruction layouts supported in the second subset of fetch granule encodings should be chosen to avoid conflict between valid instruction encodings and valid layout descriptor encodings. Hence, bytes [E, F] are encoded so that the set of valid encodings for instruction layouts where byte [E] represents part of an instruction are non-overlapping with the set of valid encodings for instruction layouts where byte [E] forms part of the layout descriptor 200.

It will be appreciated that FIG. 9 shows just one possible example encoding scheme, and there is great flexibility to vary the choice of which particular instruction lengths are supported within a given layout of the fetch granule and the particular way the bytes of the fetch granule are partitioned between respective instructions of the fetch granule. In the example of FIG. 9, the fetch granule is partitioned at granularity of bytes, but it will be appreciated that other examples could allow the bits within a single byte to be partitioned between different instructions or between an instruction and part of the layout descriptor 200.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

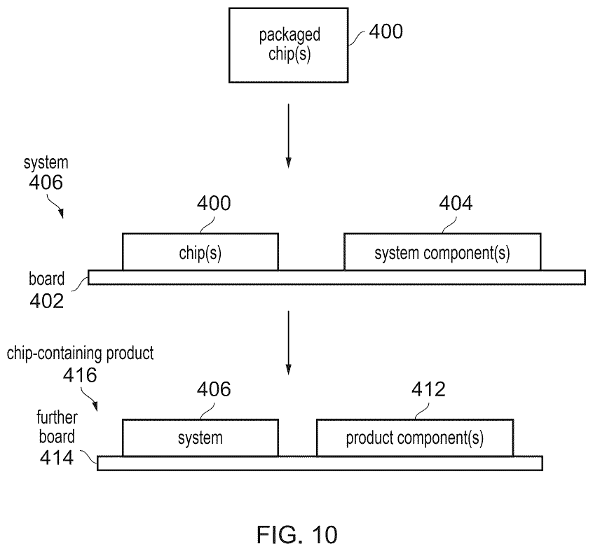

As shown in FIG. 10, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

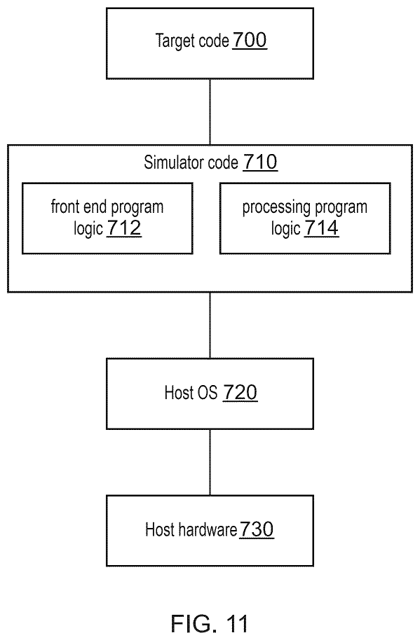

FIG. 11 illustrates a simulator implementation that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 730, optionally running a host operating system 720, supporting the simulator program 710. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 730), some simulated embodiments may make use of the host hardware, where suitable.

The simulator program 710 may be stored on a computer-readable storage medium (which may be a non-transitory medium), and provides a program interface (instruction execution environment) to the target code 700 (which may include applications, operating systems and a hypervisor) which is the same as the interface of the hardware architecture being modelled by the simulator program 710. Thus, the program instructions of the target code 700, including instructions processed in the variable-length instruction set mode discussed above, may be executed from within the instruction execution environment using the simulator program 710, so that a host computer 730 which does not actually have the hardware features of the apparatus 2 discussed above can emulate these features.

For example, the simulator code 710 may include front end program logic 712 configured to fetch and decode instructions of the target program code according to the architectural encoding constraints discussed above for the variable-length instruction set mode; and processing program logic 714 configured to control the host data processing apparatus to perform data processing corresponding to the instructions decoded by the front end program logic 712. The front end program logic 712 could for example include instructions for extracting the functional bits of an instruction of the target code from within its G-bit fetch granule, and instructions defining “if-then-else” functionality or conditional branch instruction functionality which selects which subsequent instructions of the simulator code 710 are executed based on analysis of the encoding of the functional bits of the instruction of the target code 700. The processing program logic 714 may comprise function routines which are conditionally selected by the instruction front end program logic 712 based on the instruction encoding of the instruction. The front end program logic 712 and/or processing program logic 714 may also advance a program counter by an amount dependent on the relative instruction alignment within a fetch granule, as in the examples above.

Such a simulator program 710 can be helpful for software developers who are developing software for a new version of the ISA, to enable the software to be developed and tested before any real hardware supporting that ISA version is ready yet. This can allow software development for the new ISA version to be developed in parallel with ongoing development of hardware supporting the new ISA version.

### Some Examples Are Set out in the Following Clauses:

1. An apparatus comprising:
front end circuitry configured to fetch and decode instructions; and
processing circuitry configured to perform data processing operations in response to instructions decoded by the front end circuitry; in which:
in a variable-length instruction set mode for processing instructions from a variable-length instruction set supporting instructions with different instruction lengths, the front end circuitry is configured to decode the instructions according to an encoding scheme in which each instruction is required to meet an architectural encoding constraint requiring that, for a given instruction processed in the variable-length instruction set mode, the given instruction is encoded fully within a G-bit fetch granule, where G is a fixed power-of-2 integer; and no valid instruction is allowed to cross a boundary between G-bit fetch granules;
in the variable-length instruction set mode, the front end circuitry is configured to decode a given G-bit fetch granule to determine, based on a predetermined subset of bit positions within the given G-bit fetch granule, whether the G-bit fetch granule is encoded according to a first subset of valid fetch granule encodings or a second subset of valid fetch granule encodings;
in each of the first subset of valid fetch granule encodings, the given G-bit fetch granule encodes a plurality of instructions of the variable-length instruction set having encodings corresponding to fixed-length instructions supported in a predetermined fixed-length legacy instruction set; and
in each of the second subset of valid fetch granule encodings, the given G-bit fetch granule encodes one or more instructions of the variable-length instruction set, including at least one instruction with a different instruction length to the instructions encoded in the first subset of valid fetch granule encodings, with a layout of the one or more instructions of the variable-length instruction set in the G-bit fetch granule identified by a layout descriptor encoded using the predetermined subset of bit positions of the given G-bit fetch granule.

2. The apparatus according to clause 1, in which valid encodings for the predetermined subset of bit positions in each of the second subset of valid fetch granule encodings are non-overlapping with valid encodings for the predetermined subset of bit positions in each of the first subset of valid fetch granule encodings.

3. The apparatus according to any of clauses 1 and 2, in which G is less than or equal to a number of bits in one cache line.

4. The apparatus according to any of clauses 1 to 3, in which the architectural encoding constraint requires that, for each instruction encoded within the given G-bit fetch granule, a start of that instruction is offset from a start of the G-bit fetch granule by a power-of-2 number of bytes.

5. The apparatus according to any preceding clause, in which the variable-length instruction set comprises one or more first-length instructions having a first instruction length and one or more second-length instructions having a second instruction length longer than the first instruction length.

6. The apparatus according to clause 5, in which an initial portion of each second-length instruction has an encoding different from any valid encoding of the one or more first-length instructions.

7. The apparatus according to any of clauses 5 and 6, in which each first-length instruction is constrained to have at least one length field having an encoding selected from one or more predetermined encodings; and
one or more bits of an initial portion of each second-length instruction, at positions corresponding to the at least one length field within the first-length instruction, are constrained to have a different value to any of the one or more predetermined encodings.

8. The apparatus according to any of clauses 5 to 7, in which the first instruction length comprises a number of bits less than or equal to N bits, where N is a power-of-2 integer, and the second instruction length comprises a number of bits greater than N and less than or equal to 2N.

9. The apparatus according to clause 8, where N=32.

10. The apparatus according to any preceding clause, in which the variable-length instruction set supports encoding at least one non-power-of-2 length instruction in at least one of the second subset of valid fetch granule encodings of the given G-bit fetch granule.

11. The apparatus according to any preceding clause, in which the architectural encoding constraint requires that any given instruction is represented by a contiguous portion of bits of the given G-bit fetch granule.

12. The apparatus according to any of clauses 1 to 10, in which the architectural encoding constraint permits at least one instruction to be represented by a two or more discontiguous portions of bits of the given G-bit fetch granule.

13. The apparatus according to any of clauses 1 to 12, in which the second subset of valid fetch granule encodings support a plurality of different instruction layouts for the given G-bit fetch granule distinguished by different encodings of the layout descriptor.

14. The apparatus according to any preceding clause, in which the G-bit fetch granule is sized to fit a single instruction of a longest supported instruction length.

15. The apparatus according to any preceding clause, in which, for an encoding of a G-bit fetch granule that represents a plurality of instructions within a single G-bit fetch granule, the front end circuitry is configured to support a branch operation specifying as a branch target any one of the plurality of instructions.

15. The apparatus according to clause 14, in which the front end circuitry is configured to identify instructions based on a program counter; and
each of the plurality of instructions corresponds to a different encoding of the program counter.

16. The apparatus according to clause 15, in which the program counter comprises a first portion of bits identifying an address of the G-bit fetch granule and a second portion of bits identifying a selected instruction of the plurality of instructions.

17. The apparatus according to any of clauses 15 and 16, comprising program counter advancement circuitry configured to increment the program counter from a first value corresponding to a current instruction to a second value advanced from the first value by a variable increment amount depending on an instruction length of the current instruction.

18. The apparatus according to any preceding clause, in which, in response to detecting an attempt to branch to a branch target corresponding to a mid-point of an instruction, the front end circuitry is configured to trigger a corrective action.

19. The apparatus according to clause 18, in which the corrective action comprises signalling an exception.

20. The apparatus according to any preceding clause, comprising an instruction cache configured to cache instructions fetched from a memory system; and
pre-decoding circuitry configured to pre-decode a given G-bit fetch granule fetched from the memory system and allocate one or more instructions to the instruction cache based on pre-decoding the given G-bit fetch granule.

21. The apparatus according to clause 20, in which the front end circuitry is configured to control instruction fetching based on pre-decode information generated by the pre-decoding circuitry and cached in the instruction cache, the pre-decode information for the given G-bit fetch granule indicating at least one of:
a layout of instructions within the given G-bit fetch granule as identified based on the layout descriptor;
a length of each instruction decoded from the given G-bit fetch granule; and
valid branch targets corresponding to the G-bit fetch granule.

22. The apparatus according to any preceding clause, in which the front end circuitry is configured to also support at least one further instruction set mode for which instructions to be processed are not required to satisfy said architectural encoding constraint used in the variable-length instruction set mode.

23. A system comprising:
the apparatus of any preceding clause, implemented in at least one packaged chip;
at least one system component; and
a board,
   wherein the at least one packaged chip and the at least one system component are assembled on the board.

24. A chip-containing product comprising the system of clause 23, wherein the system is assembled on a further board with at least one other product component.

25. Computer-readable code for fabrication of an apparatus according to any of clauses 1 to 21.

26. A computer program comprising instructions which, when executed by a host data processing apparatus, control the host data processing apparatus to provide an instruction execution environment for execution of target program code, the computer program comprising:
front end program logic configured to fetch and decode instructions of the target program code; and
processing program logic configured to control the host data processing apparatus to perform data processing operations in response to the instructions fetched and decoded by the front end program logic; in which:
in a variable-length instruction set mode for processing instructions from a variable-length instruction set supporting instructions with different instruction lengths, the front end program logic is configured to decode the instructions according to an encoding scheme in which each instruction is required to meet an architectural encoding constraint requiring that, for a given instruction processed in the variable-length instruction set mode, the given instruction is encoded fully within a G-bit fetch granule, where G is a fixed power-of-2 integer, and no valid instruction is allowed to cross a boundary between G-bit fetch granules;
in the variable-length instruction set mode, the front end program logic is configured to decode a given G-bit fetch granule to determine, based on a predetermined subset of bit positions within the given G-bit fetch granule, whether the G-bit fetch granule is encoded according to a first subset of valid fetch granule encodings or a second subset of valid fetch granule encodings;
in each of the first subset of valid fetch granule encodings, the given G-bit fetch granule encodes a plurality of instructions of the variable-length instruction set having encodings corresponding to fixed-length instructions supported in a predetermined fixed-length legacy instruction set; and
in each of the second subset of valid fetch granule encodings, the given G-bit fetch granule encodes one or more instructions of the variable-length instruction set, including at least one instruction with a different instruction length to the instructions encoded in the first subset of valid fetch granule encodings, with a layout of the one or more instructions of the variable-length instruction set in the G-bit fetch granule identified by a layout descriptor encoded using the predetermined subset of bit positions of the given G-bit fetch granule.

27. A storage medium storing the computer program of clause 26.

28. A method comprising:
fetching and decoding instructions using front end circuitry; and
in response to the instructions fetched and decoded by the front end circuitry, performing data processing operations using processing circuitry; in which:
in a variable-length instruction set mode for processing instructions from a variable-length instruction set supporting instructions with different instruction lengths, the front end circuitry decodes the instructions according to an encoding scheme in which each instruction is required to meet an architectural encoding constraint requiring that, for a given instruction processed in the variable-length instruction set mode, the given instruction is encoded fully within a G-bit fetch granule, where G is a fixed power-of-2 integer, and no valid instruction is allowed to cross a boundary between G-bit fetch granules;
in the variable-length instruction set mode, decoding of a given G-bit fetch granule comprises determining, based on a predetermined subset of bit positions within the given G-bit fetch granule, whether the G-bit fetch granule is encoded according to a first subset of valid fetch granule encodings or a second subset of valid fetch granule encodings;
in each of the first subset of valid fetch granule encodings, the given G-bit fetch granule encodes a plurality of instructions of the variable-length instruction set having encodings corresponding to fixed-length instructions supported in a predetermined fixed-length legacy instruction set; and
in each of the second subset of valid fetch granule encodings, the given G-bit fetch granule encodes one or more instructions of the variable-length instruction set, including at least one instruction with a different instruction length to the instructions encoded in the first subset of valid fetch granule encodings, with a layout of the one or more instructions of the variable-length instruction set in the G-bit fetch granule identified by a layout descriptor encoded using the predetermined subset of bit positions of the given G-bit fetch granule.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
front end circuitry configured to fetch and decode instructions; and
processing circuitry configured to perform data processing operations in response to instructions decoded by the front end circuitry; in which:
in a variable-length instruction set mode for processing instructions from a variable-length instruction set supporting instructions with different instruction lengths, the front end circuitry is configured to decode the instructions according to an encoding scheme in which each instruction is required to meet an architectural encoding constraint requiring that, for a given instruction processed in the variable-length instruction set mode, the given instruction is encoded fully within a G-bit fetch granule, where G is a fixed power-of-2 integer, and no valid instruction is allowed to cross a boundary between G-bit fetch granules;
in the variable-length instruction set mode, the front end circuitry is configured to decode a given G-bit fetch granule to determine, based on a predetermined subset of bit positions within the given G-bit fetch granule, whether the G-bit fetch granule is encoded according to a first subset of valid fetch granule encodings or a second subset of valid fetch granule encodings;
in each of the first subset of valid fetch granule encodings, the given G-bit fetch granule encodes a plurality of instructions of the variable-length instruction set having encodings corresponding to fixed-length instructions supported in a predetermined fixed-length legacy instruction set; and
in each of the second subset of valid fetch granule encodings, the given G-bit fetch granule encodes one or more instructions of the variable-length instruction set, including at least one instruction with a different instruction length to the instructions encoded in the first subset of valid fetch granule encodings, with a layout of the one or more instructions of the variable-length instruction set in the G-bit fetch granule identified by a layout descriptor encoded using the predetermined subset of bit positions of the given G-bit fetch granule.

2. The apparatus according to claim 1, in which valid encodings for the predetermined subset of bit positions in each of the second subset of valid fetch granule encodings are non-overlapping with valid encodings for the predetermined subset of bit positions in each of the first subset of valid fetch granule encodings.

3. The apparatus according to claim 1, in which G is less than or equal to a number of bits in one cache line.

4. The apparatus according to claim 1, in which the architectural encoding constraint requires that, for each instruction encoded within the G-bit fetch granule, a start of that instruction is offset from a start of the G-bit fetch granule by a power-of-2 number of bytes.

5. The apparatus according to claim 1, in which the variable-length instruction set comprises one or more first-length instructions having a first instruction length and one or more second-length instructions having a second instruction length longer than the first instruction length.

6. The apparatus according to claim 1, in which the variable-length instruction set supports encoding at least one non-power-of-2 length instruction in at least one of the second subset of valid fetch granule encodings of the given G-bit fetch granule.

7. The apparatus according to claim 1, in which the second subset of valid fetch granule encodings support a plurality of different instruction layouts for the given G-bit fetch granule distinguished by different encodings of the layout descriptor.

8. The apparatus according to claim 1, in which the G-bit fetch granule is sized to fit a single instruction of a longest supported instruction length.

9. The apparatus according to claim 1, in which, for an encoding of a G-bit fetch granule that represents a plurality of instructions within a single G-bit fetch granule, the front end circuitry is configured to support a branch operation specifying as a branch target any one of the plurality of instructions.

10. The apparatus according to claim 9, in which the front end circuitry is configured to identify instructions based on a program counter; and
each of the plurality of instructions corresponds to a different encoding of the program counter.

11. The apparatus according to claim 10, in which the program counter comprises a first portion of bits identifying an address of the G-bit fetch granule and a second portion of bits identifying a selected instruction of the plurality of instructions.

12. The apparatus according to claim 1, in which, in response to detecting an attempt to branch to a branch target corresponding to a mid-point of an instruction, the front end circuitry is configured to trigger a corrective action.

13. The apparatus according to claim 11, in which the corrective action comprises signalling an exception.

14. The apparatus according to claim 1, comprising an instruction cache configured to cache instructions fetched from a memory system; and
pre-decoding circuitry configured to pre-decode a given G-bit fetch granule fetched from the memory system and allocate one or more instructions to the instruction cache based on pre-decoding the given G-bit fetch granule.

15. The apparatus according to claim 14, in which the front end circuitry is configured to control instruction fetching based on pre-decode information generated by the pre-decoding circuitry and cached in the instruction cache, the pre-decode information for the given G-bit fetch granule indicating at least one of:
a layout of instructions within the given G-bit fetch granule as identified based on the layout descriptor;
a length of each instruction decoded from the given G-bit fetch granule; and
valid branch targets corresponding to the G-bit fetch granule.

16. The apparatus according to claim 1, in which the front end circuitry is configured to also support at least one further instruction set mode for which instructions to be processed are not required to satisfy said architectural encoding constraint used in the variable-length instruction set mode.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A non-transitory computer-readable storage medium storing computer-readable code for fabrication of an apparatus according to claim 1.

20. A non-transitory computer-readable storage medium storing a computer program comprising instructions which, when executed by a host data processing apparatus, control the host data processing apparatus to provide an instruction execution environment for execution of target program code, the computer program comprising:
front end program logic configured to fetch and decode instructions of the target program code; and
processing program logic configured to control the host data processing apparatus to perform data processing operations in response to the instructions fetched and decoded by the front end program logic; in which:
in a variable-length instruction set mode for processing instructions from a variable-length instruction set supporting instructions with different instruction lengths, the front end program logic is configured to decode the instructions according to an encoding scheme in which each instruction is required to meet an architectural encoding constraint requiring that, for a given instruction processed in the variable-length instruction set mode, the given instruction is encoded fully within a G-bit fetch granule, where G is a fixed power-of-2 integer, and no valid instruction is allowed to cross a boundary between G-bit fetch granules;
in the variable-length instruction set mode, the front end program logic is configured to decode a given G-bit fetch granule to determine, based on a predetermined subset of bit positions within the given G-bit fetch granule, whether the G-bit fetch granule is encoded according to a first subset of valid fetch granule encodings or a second subset of valid fetch granule encodings;
in each of the first subset of valid fetch granule encodings, the given G-bit fetch granule encodes a plurality of instructions of the variable-length instruction set having encodings corresponding to fixed-length instructions supported in a predetermined fixed-length legacy instruction set; and
in each of the second subset of valid fetch granule encodings, the given G-bit fetch granule encodes one or more instructions of the variable-length instruction set, including at least one instruction with a different instruction length to the instructions encoded in the first subset of valid fetch granule encodings, with a layout of the one or more instructions of the variable-length instruction set in the G-bit fetch granule identified by a layout descriptor encoded using the predetermined subset of bit positions of the given G-bit fetch granule.

21. A method comprising:
fetching and decoding instructions using front end circuitry; and
in response to the instructions fetched and decoded by the front end circuitry, performing data processing operations using processing circuitry; in which:
in a variable-length instruction set mode for processing instructions from a variable-length instruction set supporting instructions with different instruction lengths, the front end circuitry decodes the instructions according to an encoding scheme in which each instruction is required to meet an architectural encoding constraint requiring that, for a given instruction processed in the variable-length instruction set mode, the given instruction is encoded fully within a G-bit fetch granule, where G is a fixed power-of-2 integer, and no valid instruction is allowed to cross a boundary between G-bit fetch granules;
in the variable-length instruction set mode, decoding of a given G-bit fetch granule comprises determining, based on a predetermined subset of bit positions within the given G-bit fetch granule, whether the G-bit fetch granule is encoded according to a first subset of valid fetch granule encodings or a second subset of valid fetch granule encodings;
in each of the first subset of valid fetch granule encodings, the given G-bit fetch granule encodes a plurality of instructions of the variable-length instruction set having encodings corresponding to fixed-length instructions supported in a predetermined fixed-length legacy instruction set; and
in each of the second subset of valid fetch granule encodings, the given G-bit fetch granule encodes one or more instructions of the variable-length instruction set, including at least one instruction with a different instruction length to the instructions encoded in the first subset of valid fetch granule encodings, with a layout of the one or more instructions of the variable-length instruction set in the G-bit fetch granule identified by a layout descriptor encoded using the predetermined subset of bit positions of the given G-bit fetch granule.
